(19) United States
(12) Patent Application Publication
(10) Pub. No.: US 2022/0009746 A1
(43) Pub. Date: Jan. 13, 2022

(54) BUFFER DEVICE FOR AN ELEVATOR SYSTEM

(71) Applicant: Inventio AG, Hergiswil (CH)

(72) Inventor: Agnaldo SANTOS, Morristown, NJ (US)

(21) Appl. No.: 17/309,026

(22) PCT Filed: Oct. 4, 2019
(86) PCT No.: PCT/EP2019/076892

§ 371 Date: Apr. 15, 2021

(30) Foreign Application Priority Data
Oct. 16, 2018 (EP) 18200745.0

(51) Int. Cl. B66B 5/28

(52) U.S. Cl. CPC B66B 5/282

(57) ABSTRACT

An elevator system with a traveling body movable in an elevator shaft includes a buffer device arranged in a shaft pit of the elevator shaft for limiting the travel path of the traveling body. The buffer device includes a leaf spring and a cushioning element mounted on a frame at the floor of the elevator shaft.

### FIELD

The invention concerns an elevator installation with a buffer device arranged or manageable in the shaft pit and such a buffer device.

### BACKGROUND

Elevator systems usually include an elevator car that can be moved within an elevator shaft. This elevator car is coupled to a counterweight in such a way that the elevator car and the counterweight can move in opposite directions. A support element is used to couple the elevator car with the counterweight. The support element is usually guided in the shaft head of the elevator shaft via pulleys.

In order to ensure the safety for passengers of the elevator car, the travel of the elevator car is limited by means of a buffer device. Such a buffer device is located below the elevator car in a shaft pit of the elevator shaft in order to limit the travel of the elevator car in the area of the shaft pit. On the other hand, such a buffer device can be arranged below the counterweight in order to limit the travel of the elevator car in the shaft head of the elevator shaft.

Usually such a buffer consists essentially of a spiral spring placed on the shaft floor. When the car or counterweight is driven onto this spiral spring, the car or counterweight is braked before the shaft floor is reached.

It is therefore a task of the invention to develop an alternative buffer device.

### SUMMARY

The task is solved by an elevator system with a traveling body movable in an elevator shaft and a buffer device arranged or manageable in a shaft pit of the elevator shaft to limit the travel distance of the traveling body, whereby the buffer device includes a leaf spring.

The task is also solved by a buffer device for an elevator system for limiting the travel distance of a traveling body, the buffer device being manageable in a shaft pit of an elevator shaft of the elevator system, the buffer device including a leaf spring.

The traveling body is preferably formed by an elevator car or a counterweight, whereby the counterweight may be present in addition to the elevator car. If such a counterweight is present, the elevator car and the counterweight are usually arranged in the elevator shaft so that they can move in opposite directions to each other.

The elevator shaft has the shaft pit at its lower end, whereby the shaft floor limits the elevator shaft at its lower end. For the purpose of this description, the shaft floor may include at least one scaffold or frame on which the buffer device is fixed or supported.

Such a design makes it possible to keep the dimensions of such a buffer device to a minimum. In particular, this design allows shaft pits with small vertical dimensions. This means that a distance between the elevator car in its position at the lowest shaft door and the shaft floor can be minimized by means of this design.

In a further development of the elevator system, the elevator car or the counterweight can be braked by means of the leaf spring. Such a leaf spring thus reduces the speed of the elevator car or the counterweight by means of its elastic properties. In the event of relief, the leaf spring can therefore be released back to its initial position.

In a further development of the elevator system, the leaf spring is formed by a semi-elliptical spring. Such a semi-elliptical spring has several spring blades arranged one above the other, which are usually held together in their middle area by a spring screw, in particular a ring bolt. Such a spring screw prevents the individual spring blades from moving in the longitudinal direction. In addition, or alternatively, the spring blades can be held together by spring clamps. The buffer system preferably comprises a suspension system portion and furthermore could comprise a damping system portion. Preferably the suspension system portion mainly consists of the semi-elliptical spring.

In a further development of the elevator installation, a central area of the semi-elliptical spring has a contact area, which is intended for contact with the elevator car or for contact with the counterweight. Preferably such a semi-elliptical spring is mounted at its outer ends so that the contact area arranged in the middle region of the semi-elliptical spring is supported on both sides by any weight of the elevator car or the counterweight impacting on the semi-elliptical spring. The contact area arranged in the middle area therefore has the greatest possible distance to these outer ends, so that the middle area of the semi-elliptical spring is as far away as possible from the shaft floor of the elevator shaft.

In a further development of the elevator system, the buffer device includes a damping element supporting the contact area, with the damping element being fixed in the shaft pit, in particular on the shaft floor. This means that the cushioning element can be fixed to the shaft floor. The cushioning element can also absorb additional vertical forces caused by the buffering of the traveling body. Such a cushioning element can, for example, be achieved by a compression spring or other elements with a cushioning effect.

In a further development of the elevator system, the semi-elliptical spring has an impact plate forming the contact area. This impact plate is intended for the contact of the elevator car or the counterweight with the buffer device. The cushioning element provides an added cushioning effect to the spring effect of the semi-elliptical spring when the elevator car or counterweight hits the buffer device. In addition, the impact plate enables the semi-elliptical spring to be protected when the elevator car or the counterweight hits the buffer device.

In a further development of the elevator system, the semi-elliptical spring has a main spring whose two main spring ends are mounted or can be mounted in the shaft pit. The semi-elliptical spring usually has a spring eye at least one end. This spring eye is mounted or can be mounted in the shaft pit. In particular, the spring eye can be pivoted on a support frame fastened in the shaft pit. The semi-elliptical spring can also have a spring eye at its second main spring end, whereby this second main spring end of the semi-elliptical spring is displaceably mounted. Such an essentially horizontal displacement of the main spring ends is necessary if the semi-elliptical spring is under load by the traveling body.

In a further development of the elevator system, the semi-elliptical spring has an additional spring whose two additional spring ends are mounted or can be mounted in the shaft pit. An additional spring of this type enables an additional spring force to be applied in the event of an increased application of force or an increased deflection of the spring due to contact with the semi-elliptical spring caused by the elevator car or the counterweight.

### DESCRIPTION OF THE DRAWINGS

In the following, the invention is explained in more detail using illustrations. They show:

FIG. 1: an elevator system with a buffer device;

FIG. 2: a buffer device with a semi-elliptical spring and a cushioning element; and

FIGS. 3A and B: several versions of semi-elliptical springs.

### DETAILED DESCRIPTION

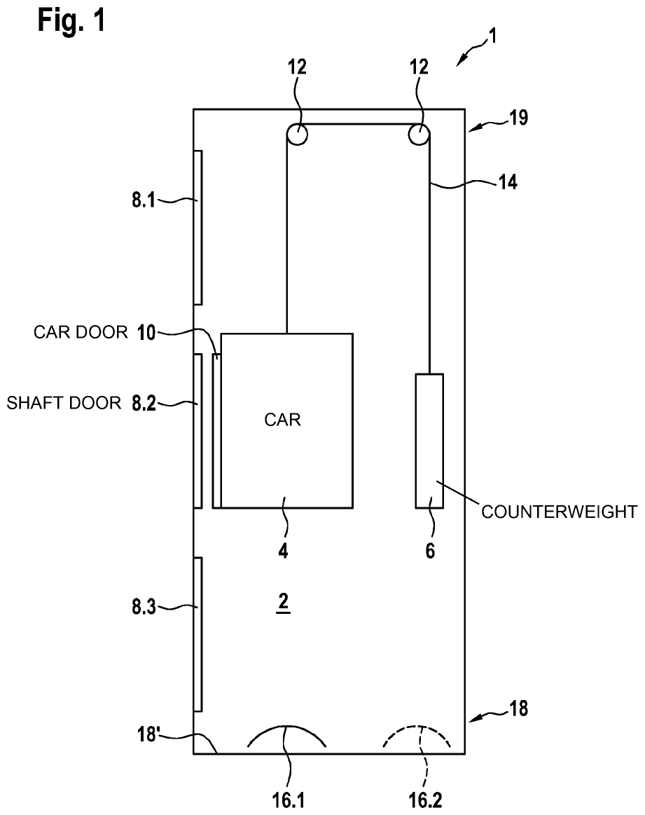

FIG. 1 shows an elevator installation 1 with an elevator shaft 2, an elevator car 4 and a counterweight 6. The elevator shaft 2 has a shaft head 19 at its upper end and a shaft pit 18 at its lower end. The elevator car 4 and the counterweight 6 are arranged so that they can move in opposite directions within the elevator shaft 2. The elevator car 4 and the counterweight 6 are connected to each other by means of a supporting element 14. The supporting element 14 is usually guided in a shaft head 19 via pulleys 12. One of these pulleys 12 can be designed as a drive roller coupled to a drive motor (not shown).

Elevator shaft 2 is bounded in shaft pit 18 by shaft floor 18′. Two buffer devices 16.1, 16.2 are usually fixed on the shaft floor 18′. The first of these buffer devices 16.1 is assigned to the elevator car 4 and the second of the buffer devices 16.2 is assigned to the counterweight 6.

The elevator car 4 has a car door 10. Depending on the position of the elevator car 4 in the elevator shaft 2, the car door 10 can be arranged on one of several shaft doors 8.1, 8.2, 8.3. If the car door 10 is arranged on one of the uppermost shaft doors 8.1, the elevator car is arranged almost at its uppermost position in elevator shaft 2. Usually, the counterweight 6 in this arrangement of the car door 10 at the top of the landing doors 8.1 is small, i.e. usually less than one meter, from the buffer device 16.2 associated with the counterweight 6.

If the car door 10 is arranged at the bottom of one of the shaft doors 8.3, however, the elevator car is arranged almost in its lowest position in the elevator shaft 2. In this arrangement of the car door 10 at the lowest of the shaft doors 8.3, the elevator car 4 is usually located at a small distance, i.e. usually less than one meter, from the buffer device 16.1 assigned to the elevator car 4.

The buffer device 16.1, 16.2 assigned to the counterweight 6 or to the elevator car 4 is arranged in the direction of travel of the counterweight 6 or the elevator car 4 at the end of the respective travel. The elevator car 4 or the counterweight 6 therefore only touch the assigned buffer device 16.1, 16.2 in the event of a fault or in an operating mode not corresponding to normal operation. Accordingly, the travel of the elevator car 4 or the counterweight 6 is limited by at least one buffer device 16.1, 16.2 in the event of a fault. By limiting the travel of the counterweight 6 in shaft pit 18, the travel of the elevator car 4 in shaft head 19 is limited due to the fact that the elevator car 4 and the counterweight 6 can move in opposite directions.

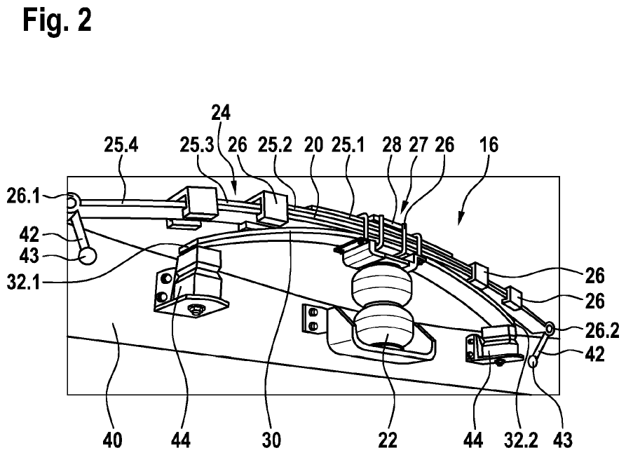

FIG. 2 shows a buffer device 16 with a leaf spring, in particular a semi-elliptical spring 24, and a cushioning element 22. The buffer device 16 is fixed or mounted on a frame 40 assigned to the shaft floor. The semi-elliptical spring 24 includes a main spring 20 and an additional spring 30. The main spring 20 and the additional spring 30 each include at least one spring leaf. The main spring 20 shown here includes several spring leaves 25.1, 25.2, 25.3, 25.4, which can be connected to each other by several spring clips 26.

The semi-elliptical spring 24 has a middle section 27 and two outer ends 26.1, 26.2 which can be assigned to the main spring 20 in the example shown. The middle section 27 of the semi-elliptical spring 24 is fixed at the first end of the cushioning element 22 and supported by this cushioning element 22. A second end of the cushioning element 22 is fixed to the frame 40.

In addition, the buffer device 16 can have an impact plate 28 which is fixed in the middle region 27 of the semi-elliptical spring 24 to provide a contact area in such a way that the elevator car 4 or counterweight 6 hitting the buffer device 16 only touches the impact plate 28 of the buffer device 16.

The outer ends 26.1, 26.2 of the main spring 20 are mounted on the frame 40. At least one of these outer ends 26.1, 26.2 is formed by a spring eye 26.1. In the example shown, the outer ends 26.1, 26.2 of the main spring are movably mounted and coupled to rigid brackets 42. The brackets 42 are pivotably arranged at bracket bearing points 43.

The additional spring 30 has two additional spring ends 32.1, 32.2. The additional spring ends 32.1, 32.2 are movably mounted on the frame 40. For this purpose, the additional spring ends 32.1 and 32.2 can be supported on the frame 40 by means of support elements 44.

The supporting elements 44 can be made of an elastic material and have an additional cushioning effect.

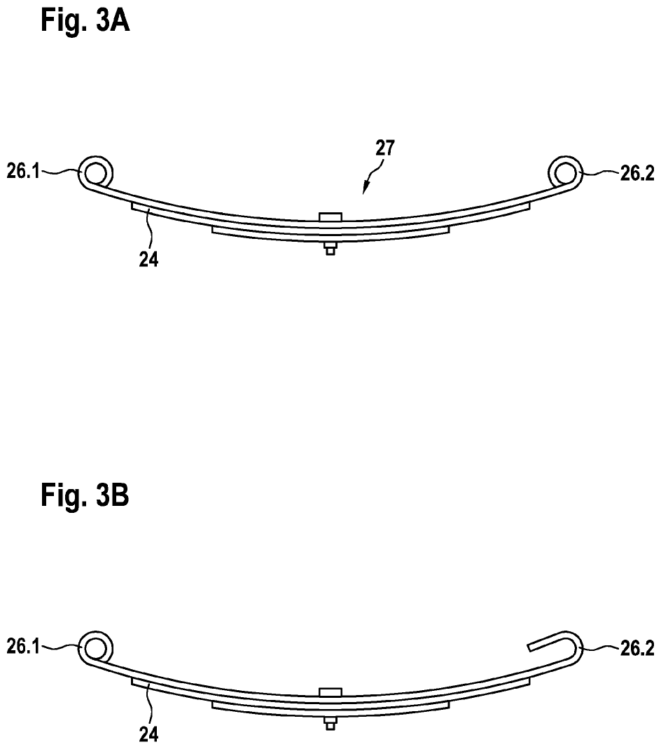

FIGS. 3A, B show various exemplary leaf springs designed as the semi-elliptical springs 24, which can be part of a buffer device of an elevator system. The semi-elliptical springs 24 shown differ essentially in the design of their outer ends 26.1, 26.2.

The semi-elliptical spring 24 shown in FIG. 3A has a spring eye 26.1, 26.2 at each of its outer ends 26.1, 26.2 for mounting, wherein at least one of the spring eyes 26.1, 26.2, preferably both, is pivotally mounted at a not shown bracket mounting point at the bottom of the shaft. In the case of a rotatable mounting of both spring eyes, it is possible that a central area 27 of the semi-elliptical spring 24 is not displaced in the direction of one of the two outer ends 26.1, 26.2 in the case of a resilient strain on the semi-elliptical spring 24. If the semi-elliptical spring 24 is mounted in such a way on the shaft floor as a component of the buffer device, this means that during the period of a braking process of the elevator car or of the counterweight by the buffer device, the central region 27 with an impact plate attached to it, if any, is essentially fixed to an underside of the elevator car or of the counterweight.

The semi-elliptical spring 24 shown in FIG. 3B has a spring eye at one of its two outer ends 26.1 and a free bearing at a second of its two outer ends 26.2. As an example, the spring eye can be fixed to the bottom of the shaft. The outer end 26.2 designed as a free bearing can, for example, be designed to slide along a bearing pin. Alternatively, the spring eye 26.1 can also be mounted so that it can swivel.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. An elevator system comprising:
a traveling body movable in an elevator shaft;
a buffer device arranged in a shaft pit of the elevator shaft for limiting a travel path of the traveling body, the buffer device including a leaf spring; and
wherein the leaf spring is formed as a semi-elliptical spring.

11. The elevator system according to claim 10 wherein the semi-elliptical spring has a middle section with a contact area adapted for contact with the traveling body.

12. The elevator system according to claim 11 wherein the semi-elliptical spring is mounted at outer ends thereof in the shaft pit so that the contact area is supported on both sides thereof for any weight of the traveling body impacting on the semi-elliptical spring.

13. The elevator system according to claim 11 wherein the buffer device includes a cushioning element supporting the contact area and the cushioning element is fixed in the shaft pit.

14. The elevator system according to claim 11 wherein the semi-elliptical spring includes an impact plate that forms the contact area.

15. The elevator system according to claim 10 wherein the traveling body is braked by contact with the leaf spring.

16. The elevator system according to claim 10 wherein the semi-elliptical spring includes a main spring with two outer ends, the outer ends being mounted in the shaft pit.

17. The elevator installation according to claim 16 wherein the semi-elliptical spring includes an additional spring, the additional spring having two spring ends mounted in the shaft pit.

18. A buffer device for an elevator system for limiting a travel distance of a traveling body, the buffer device comprising: a leaf spring formed as a semi-elliptical spring; and wherein the buffer device is adapted to be arranged in a shaft pit of an elevator shaft of the elevator system for contact by the traveling body thereby limiting the travel distance of the traveling body.

19. A buffer device for limiting a travel path of the traveling body in an elevator shaft when the buffer device is arranged in a shaft pit of the elevator shaft, the buffer device comprising:
a leaf spring formed as a semi-elliptical spring including a main spring and another spring;
wherein the semi-elliptical spring has a middle section with a contact area adapted for contact with the traveling body;
wherein the main spring is mounted at outer ends thereof in the shaft pit so that the contact area is supported on opposite sides thereof for any weight of the traveling body impacting on the semi-elliptical spring;
wherein the semi-elliptical spring includes an impact plate that forms the contact area;
wherein the additional spring has two spring ends mounted in the shaft pit; and
a cushioning element supporting the contact area and being fixed in the shaft pit.
